(19) United States
(12) Patent Application Publication
(10) Pub. No.: US 2004/0111415 A1
(43) Pub. Date: Jun. 10, 2004

(54) Automatic organization of images uploaded to a photo-sharing site

(76) Inventors: Patricia Scardino, Apex, NC (US); Robert P. Morris, Raleigh, NC (US); Hugh Blake Svendsen, Cary, NC (US)

Correspondence Address: SAWYER LAW GROUP LLP, P O BOX 51418, PALO ALTO, CA, 94303, US

(21) Appl. No.: 10/310,527

(22) Filed: Dec. 4, 2002

(51) Int. Cl. G06F 7/00; G06F 15/16; G09G 5/00

(52) U.S. Cl. 707/10; 709/219; 345/748; 709/203

(57) ABSTRACT

A method for automatically organizing images uploaded from a computer to a server is disclosed. Aspects of the invention include receiving an upload of image files from the computer on the server, where the upload includes a folder hierarchy defining how the image files are stored on the computer. The images files are then automatically stored and organized on the server, such that the folder hierarchy of the image files is preserved.

### FIELD OF THE INVENTION

The present invention relates to digital images, and more particularly, to a method for uploading images to on a photo-sharing site, with automatic storage organization.

### BACKGROUND OF THE INVENTION

Many online photo sharing sites allow users to upload digital images for storage and to manually organize their photos into groups called albums. However, they require the user to put images into specific albums during or after the upload process. Many users have already built up a collection of digital files on their PC's, but do not at this point trust the existing photo sharing sites with permanent archival of photo files. Therefore, users typically upload a select few images for sharing, but maintain storage of their entire image collection on their PC's. If their image collection is large enough, they probably have organized the files into different folders on their PC to help them find images when they want them.

As photo-sharing site servers become more secure and reliable, users will want to place their entire image collection on the server. However, user's will not want to upload hundreds or thousands of files and manually organize the images on the photo sharing site by selecting specific albums or creating new albums in which to store the images. This would be a tedious and time-consuming process that most users will want to avoid, thereby negatively impacting the rate of adoption of photo sharing sites.

Accordingly, what is needed is an improved method and system for uploading images from a user's computer to a photo sharing site for storage. The present invention addresses such a need.

### SUMMARY OF THE INVENTION

The present invention provides a method for automatically organizing images uploaded from a computer to a server. Aspects of the invention include receiving an upload of image files from the computer on the server, where the upload includes a folder hierarchy defining how the image files are stored on the computer. The images files are then automatically stored and organized on the server, such that the folder hierarchy of the image files is preserved.

According to the method and system disclosed herein, the user is alleviated from having to recreate the storage organization they have created on their computer when uploading image(s) to a photo sharing site, thereby making the upload process more user-friendly.

### BRIEF DESCRIPTION OF THE DRAWINGS

FIG. 1 is a block diagram illustrating an automatic upload organizational system in a preferred embodiment of the present invention.

FIG. 2 is a diagram of an Explorer window displayed on the computer showing an example file hierarchy.

FIG. 3 is a flow diagram illustrating a process for automatically organizing images uploaded to the server from the computer in a preferred embodiment of the present invention.

FIG. 4 is a diagram illustrating an example user interface screen displayed to the user of the upload application.

FIG. 5 is a diagram of an example path for the image file highlighted in FIG. 1.

### DESCRIPTION OF THE INVENTION

The present invention relates to uploading images from a computer to a server for storage and for automatically organizing the uploaded images on the server. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

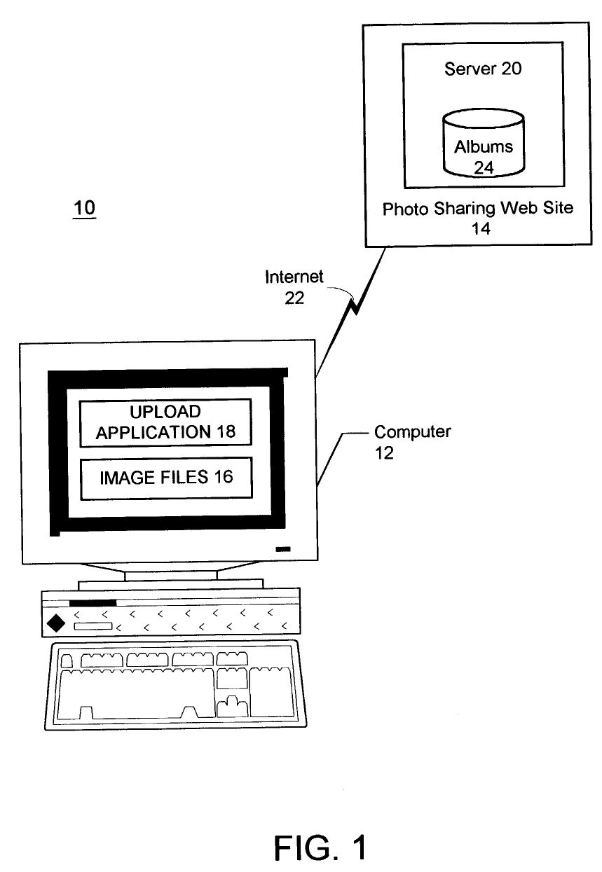

FIG. 1 is a block diagram illustrating an automatic upload and organizational system in a preferred embodiment of the present invention. The system 10 includes a workstation or PC (hereinafter computer 12), and a photosharing site 14 that allows a user to upload digital images files 16 from the computer 12 for storage. The computer 12 further includes an image upload application 18 that operates in accordance with the present invention for uploading the images 16 to a server 20 at the photosharing site 14 via a network, such as the Internet 22. Once the image files 16 are uploaded from the computer 12, the server 20 stores the images 16 in on-line image albums 24, and makes the albums 24 available over the internet 22 for viewing. It should also be readily understood that the computer 12 could also represent a dedicated box that executes the image upload application 18 and displays the images on a display, such as television, for instance.

The image files 16 may be input into the computer 12 from a variety of sources (not shown), such as a digital camera, CD, DVD, or a scanner, for instance. The image files 16 may be stored on a storage device (not shown), such as a hard drive, CDR, DVDR, or an imaging device attached to the computer. As is well-known in the art, files in the computer 12 are stored in a folder hierarchy. Note, each folder in the folder hierarchy may store subfolders and files, and subfolders may also be referred to as folders. The route to each image stored in the folder hierarchy is known as a path. A user may navigate the files on the computer 12 within individual software applications executing on the computer 12 or with an operating system file manager utility, such as Explorer™ in Microsoft Windows™.

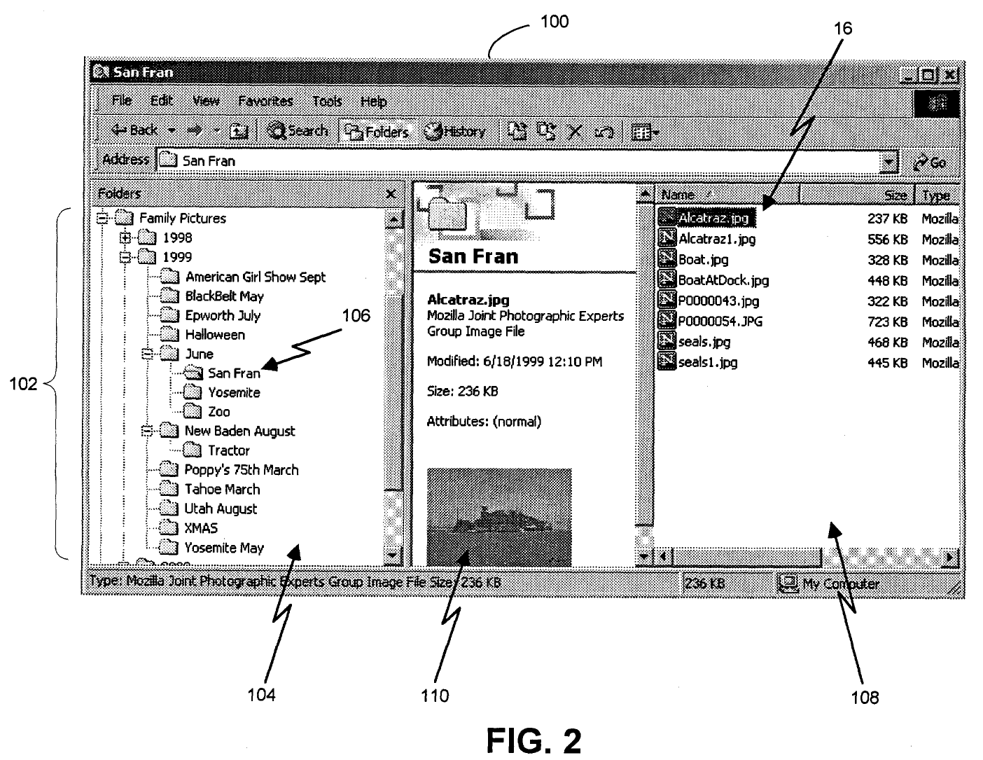

FIG. 2 is a diagram of an Explorer window displayed on the computer 12 showing an example file hierarchy. The Explorer window 100 displays a folder hierarchy 102 of all storage devices (hard disk, floppy etc.) in left windowpane 104. The folder hierarchy 102 shows the relationship between the folders 106 the user has created. Each folder 106 may contain files and/or other folders. As the user navigates down the layers of folders 106, the user is following the path to particular file 16. Right windowpane 108 displays the folders 106 and files 16 that are in a folder 106 that is currently selected in the left windowpane 104. These are all standard features of the Windows™ operating system.

The example in FIG. 2 shows an example folder hierarchy 102 of how a user could choose to organize their image files 16—by year and then by activity or by year, by month and then by activity. For example, the folder named ‘San Fran’ is inside the folder named ‘June’ which is inside the folder named ‘1999’ which is inside the folder named ‘Family Pictures’. The ‘San Fran’ folder 106 is currently selected, and all image files 16 inside ‘San Fran’ are displayed in the right windowpane 108. The File 16 ‘Alcatraz.jpg’ is currently selected and a thumbnail 110 representation of this file may also be displayed.

The present invention takes advantage of the organizational work the user has already done with their files on their computer 12 when uploading the images 16 to the photosharing site 14.

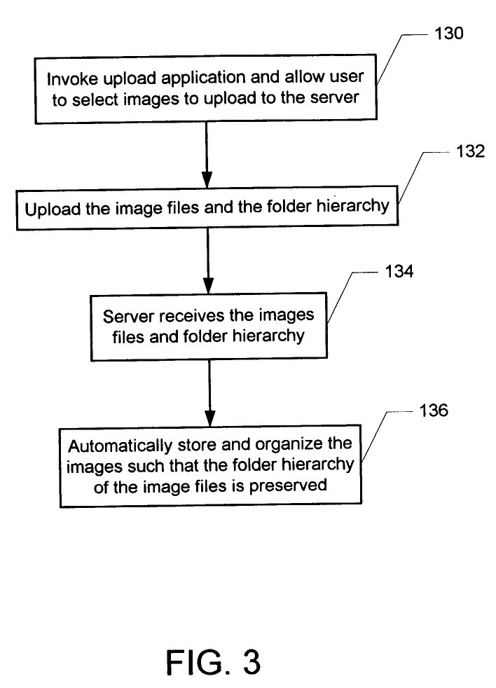

FIG. 3 is a flow diagram illustrating a process for automatically organizing images uploaded to the server from the computer in a preferred embodiment of the present invention. The process begins in step 130 when the user invokes the upload application 18 and selects a collection of images 108 to upload to the server 20.

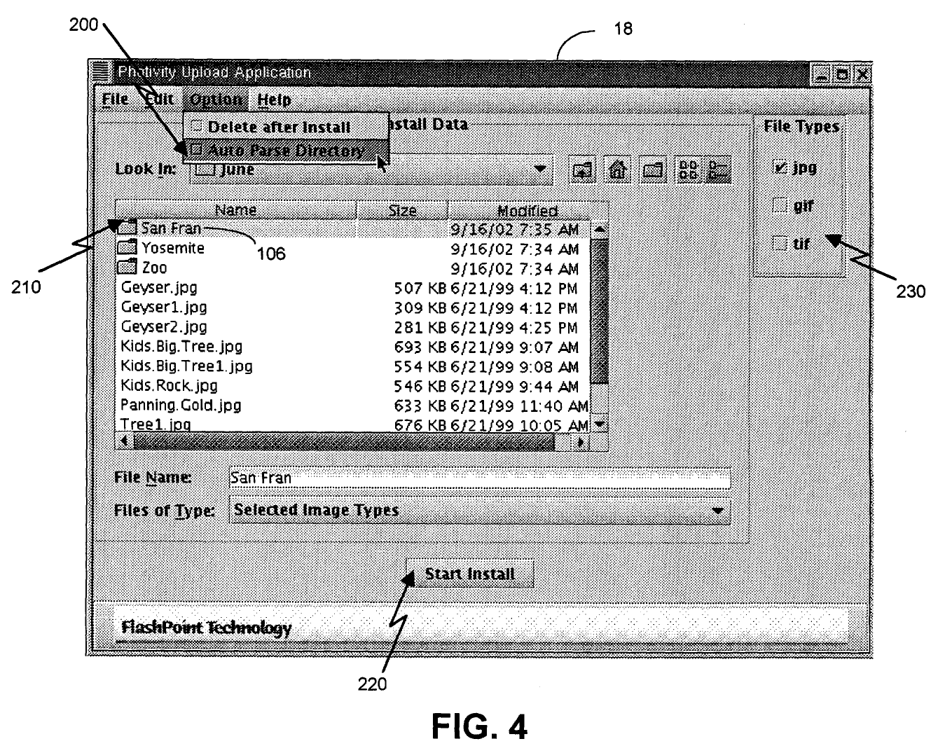

FIG. 4 is a diagram illustrating an example user interface screen displayed to the user of the upload application 18. To upload images, the upload application 18 displays a folder hierarchy windowpane 210 to allow the user to browse the files 16 stored on the computer 12. In a preferred embodiment, the upload application 18 allows the user to enter search criteria 230, such as file types. The upload application 18 also includes an auto upload feature, which is invoked once the user has selected a particular folder 106 and presses the ‘Start Install’ button 220. In response, the application 18 takes the selected folder 106 as input and searches through this folder 106 and all subfolders for files 16 that match the selected criteria 230. In an alternative embodiment, the upload application 18 may assume the user has placed their images 16 in a predetermined folder 106 on the computer 12. In another preferred embodiment, the application 18 may search for a predetermined type of file 16 to search for instead of allowing the user to select the type.

Referring again to FIG. 3, after the user selects a folder 106, in step 132 the upload application 18 uploads the image files 16 found in the folder (and subfolders), and the folder hierarchy 102 for the images 16. In a preferred embodiment, the folder hierarchy 102 is transmitted by uploading the path of the files 16 to the server 20.

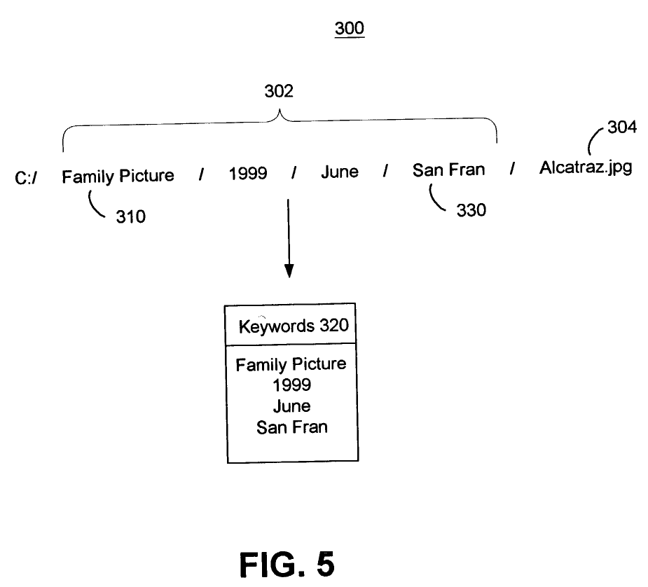

FIG. 5 is a diagram of an example path 300 for the image file 16 highlighted in FIG. 1. As shown, the path 300 includes a device indicator, in this case “C,” a series of one or more folder names 302 ordered from highest 310 to lowest 330, and a file name 304 following the last folder name 330.

Referring again to FIG. 3, the server 20 receives the images files 16 and folder hierarchy 102 in step 134. According to the present invention, the server 20 then automatically stores and organizes the images 108 in step 136, such that the folder hierarchy 102 of the image files 16 is preserved on the server 20.

In a preferred embodiment, this is accomplished by the server 20 parsing the folder hierarchy 102 received for the image collection and creating albums 24 that are named after the folder names 302 in the folder hierarchy 102. As shown in FIG. 4, the upload application 18 may include an options setting 200 that allows the user to have the server 20 automatically organize the image files 16 in this manner upon upload. The image files 16 are then stored in the album 24 corresponding to the folder 106 in which they were stored on the user's computer 12. There are a variety of embodiments for creating albums 24 in this manner.

A first embodiment for creating on-line albums from the path 300 is to parse the path 300 of each image file 16, create an album 24 named after the last folder 330 in the path (assuming that the album has not yet been created from a previous image 16 in the upload session), and then store the image 16 in the album 24. For the example path 300 shown in FIG. 3, for the file ‘Alcatraz.jpg;’ 304, the name of the folder that the file resides in, ‘San Fran’, becomes the name of a new album 24 on the server 20. Once this album 24 has been created, all the files uploaded from the ‘San Fran’ folder would be added to it.

Referring still to FIG. 5, the server 20 also creates a list of keywords 320 from the folder names 302 in the path 300, and associates this keyword list 320 with the corresponding image files 16 on the server 20. The user may then subsequently find a specific image or images 16 on the server 20 by entering search terms. The server 20 would then search the keyword lists 320 using the search terms to find the image(s) 16. In an alternative embodiment, assuming that the user has created a file-naming scheme for remembering the content of the image file 16, the file name 304 of each image file 16 may be parsed to create the list keywords of 320.

According to another aspect of the present invention, the server 20 creates a unique upload ID for every folder (and subfolder) encountered during an upload session, and assigns the corresponding upload ID to the image files 16 found in the respective folders that were uploaded during that session so that the user can quickly find all the images 16 that were uploaded during the same session.

A second embodiment for creating on-line albums from the path 300 is to create an album 24 named after all the folder names 302 in the path 300 and then store the corresponding images 16 in the album 24. For the example shown in FIGS. 1 and 3, the album name for all the images 109 in the ‘San Fran’ folder would be ‘Family Pictures 1999 June San Fran.’

A third embodiment for creating on-line albums is to create nested albums on the server 20 (albums within albums) based on the uploaded folder hierarchy 102. The server 20 would then display the album hierarchy graphically to create a visual for the user that is similar to the computer file system layout. According to this aspect of the present invention, supporting nested albums 24 preserves not only the relationship between the lowest-level folder 330 and their files 16, but also the relationship between folders 106 and other folders 106.

According to a further aspect of the present invention, rather than uploading the path 300 of the image files 16 to preserve the folder hierarchy 102 on the server 20, the server 20 extracts metadata from the image files 16 and uses the metadata to create a storage organization on the server 20. One example type of metadata includes GPS data. If the user has entered GPS metadata into the image files 16 and wants to store the image files 16 on the server 20 based on that information, then the server 20 could create albums 24 based on the country code in the GPS data, for example.

The present invention has been described in accordance with the embodiments shown, and one of ordinary skill in the art will readily recognize that there could be variations to the embodiments, and any variations would be within the spirit and scope of the present invention. For example, rather than the album organization being created by the server, the upload application could perform the function of parsing the folder hierarchy, and creating and uploading the album organization to the server along with the image files. Accordingly, many modifications may be made by one of ordinary skill in the art without departing from the spirit and scope of the appended claims.

What is claimed is:

1 A method for automatically organizing images uploaded from a computer to a server, comprising the steps of:
(a) receiving an upload of image files from the computer on the server, including a folder hierarchy defining how the image files are stored on the computer; and
(b) automatically storing and organizing the image files on the server, such that the folder hierarchy of the image files is preserved.

2 The method of claim 1 wherein the folder hierarchy includes at least one folder name, step (a) further including the step of: parsing the folder hierarchy and creating on-line albums that are named after the folder names in the folder hierarchy.

3 The method of claim 2 wherein step (a) further includes the step of:
receiving the folder hierarchy as respective paths for each image, wherein each path includes a device indicator, one or more folder names ordered from highest to lowest, and a file name following a last folder name.

4 The method of claim 3 wherein step (b) further includes the step of:
storing each image in an on-line album that is named after the last folder name in the path of the image file.

5 The method of claim 3 wherein step (b) further includes the step of:
creating a list of keywords from the folder names in the path for each respective image file, and associating the keyword list with the image file, such that the keywords can be used as search criteria for subsequent image searches on the server.

6 The method of claim 5 further including the step of: parsing the file name of each image file to create the list keywords.

7 The method of claim 3 wherein step (b) further includes the step of:
creating a unique upload ID for every folder encountered during an upload session and assigning the corresponding upload ID to the image files found in the respective folders that were uploaded during that session so that a user can quickly find all the images uploaded during the same session.

8 The method of claim 3 wherein step (b) further includes the step of:
creating an album named after a plurality of the folder names in the path, and storing the corresponding image files in the album.

9 The method of claim 3 wherein step (b) further includes the step of:
creating nested albums on the server based on the uploaded folder hierarchy, and storing the image files in the albums that correspond to the folders in which the images files were stored.

10 The method of claim 3 wherein step (b) further includes the step of:
extracting metadata from the image files, and using the metadata to create a storage organization on the server.

11 The method of claim 10 wherein the metadata includes GPS data, and the server creates albums named after the GPS data.

12 The method of claim 3 wherein step (a) further includes the step of: using an upload application to upload the image files from the computer to the server, wherein the upload application parses the folder hierarchy, creates an album organization for the server, and uploads the album organization to the server along with the image files.

13 A method for automatically organizing images uploaded from a computer to a server, comprising the steps of:
(a) receiving an upload of image files from the computer on the server, including a path for each image file, wherein each path includes at least a folder name and an image file name;
(b) creating a list of keywords from the folder names in the respective paths;
(c) storing the image files on the server; and
(d) associating the list of keywords with the respective image files on the server, such that the server can search the list of keywords to find specific images.

14 The method of claim 13 wherein step (c) further includes the steps of:
creating an album that is named after a last folder name in the path, and storing the image files in the album.

15 A computer-readable medium containing program instructions for automatically organizing images uploaded from a computer to a server, the program instructions for:
(a) receiving an upload of image files from the computer on the server, including a folder hierarchy defining how the image files are stored on the computer; and
(b) automatically storing and organizing the image files on the server such that the folder hierarchy of the image files is preserved.

16 The computer-readable medium of claim 15 wherein the folder hierarchy includes at least one folder name, instruction (a) further including the instruction of:
parsing the folder hierarchy and creating on-line albums that are named after the folder names in the folder hierarchy.

17 The computer-readable medium of claim 16 wherein instruction (a) further includes the instruction of: receiving the folder hierarchy as respective paths for each image, wherein each path includes a device indicator, one or more folder names ordered from highest to lowest, and a file name following a last folder name.

18 The computer-readable medium of claim 17 wherein instruction (b) further includes the instruction of: storing each image in an on-line album that is named after the last folder name in the path of the image file.

19 The computer-readable medium of claim 17 wherein instruction (b) further includes the instruction of: creating a list of keywords from the folder names in the path for each respective image file, and associating the keyword list with the image file, such that the keywords can be used as search criteria for subsequent image searches on the server.

20 The computer-readable medium of claim 19 further including the instruction of: parsing the file name of each image file to create the list keywords.

21 The computer-readable medium of claim 17 wherein instruction (b) further includes the instruction of: creating a unique upload ID for every folder encountered during an upload session and assigning the corresponding upload ID to the image files found in the respective folders that were uploaded during that session so that a user can quickly find all the images uploaded during the same session.

22 The computer-readable medium of claim 17 wherein instruction (b) further includes the instruction of: creating an album named after a plurality of the folder names in the path, and storing the corresponding image files in the album.

23 The computer-readable medium of claim 17 wherein instruction (b) further includes the instruction of: creating nested albums on the server based on the uploaded folder hierarchy, and storing the image files in the albums that correspond to the folders in which the images files were stored.

24 The computer-readable medium of claim 17 wherein instruction (b) further includes the instruction of: extracting metadata from the image files, and using the metadata to create a storage organization on the server.

25 The computer-readable medium of claim 24 wherein the metadata includes GPS data, and the server creates albums named after the GPS data.

26 The computer-readable medium of claim 17 wherein instruction (a) further includes the instruction of: using an upload application to upload the image files from the computer to the server, wherein the upload application parses the folder hierarchy, creates an album organization for the server, and uploads the album organization to the server along with the image files.

27 A method for automatically organizing images uploaded from a computer to a server, comprising the steps of:
(a) receiving an upload of image files from the computer on the server;
(b) creating a unique upload ID for every folder encountered during an upload session; and
(c) assigning the corresponding upload ID to the image files found in the respective folders that were uploaded during that session so that a user can quickly find all the images uploaded during the same session.

28 A method for automatically organizing images uploaded from a computer to a server, comprising the steps of:
(a) extracting metadata from the image files on the computer;
(b) uploading the image files and the metadata from the computer to the server; and
(c) using the metadata to automatically store and organize the image files on the server.

29 A method for automatically organizing images uploaded from a computer to a server, comprising the steps of:
(a) parsing a folder hierarchy on the computer to create an album organization for the images;
(b) uploading image files and the album organization to the server from the computer; and
(c) using the album organization to store the image files on the server.

30 A computer-readable medium containing program instructions for automatically organizing images uploaded from a computer to a server, the program instructions for:
(a) receiving an upload of image files from the computer on the server;
(b) creating a unique upload ID for every folder encountered during an upload session; and
(c) assigning the corresponding upload ID to the image files found in the respective folders that were uploaded during that session so that a user can quickly find all the images uploaded during the same session.

31 A computer-readable medium containing program instructions for automatically organizing images uploaded from a computer to a server, the program instructions for:
(a) extracting metadata from the image files on the computer;
(b) uploading the image files and the metadata from the computer to the server; and
(c) using the metadata to automatically store and organize the image files on the server.

32 A computer-readable medium containing program instructions for automatically organizing images uploaded from a computer to a server, the program instructions for:
(a) parsing a folder hierarchy on the computer to create an album organization for the images;
(b) uploading image files and the album organization to the server from the computer; and
(c) using the album organization to store the image files on the server.
